(19) United States
(12) Patent Application Publication
(10) Pub. No.: US 2015/0034732 A1
(43) Pub. Date: Feb. 5, 2015

(54) ARTICULATED WATERING DEVICE

(71) Applicant: Droplet Robotics Inc., Hayward, CA (US)

(72) Inventor: Steve FERNHOLZ, Hayward, CA (US)

(21) Appl. No.: 14/447,097

(22) Filed: Jul. 30, 2014

Related U.S. Application Data
(60) Provisional application No. 61/861,295, filed on Aug. 1, 2013.

(51) Int. Cl. A01G 25/16

(52) U.S. Cl. CPC A01G 25/16
USPC 239/1; 239/69

(57) ABSTRACT

An electronically controlled device which can provide fluid delivery to targeted areas in a scheduled and repeatable manner, without providing fluid delivery inconsequentially to untargeted areas. In one example, the device includes one more nozzles for directing a fluid, one or more motors for controlling the pitch and the yaw of the one or more nozzles, one or more valves for controlling the flow of fluid to the nozzle, and a controller for selectively directing the one or more nozzles to direct fluid in a predetermined pattern. The controller may include a visual interface for providing the predetermined pattern and/or volumes of water, and may further be included with or remote to the device.

### CROSS-REFERENCE TO RELATED APPLICATION

This application claims priority to U.S. Provisional Patent Application No. 61/861,295, filed on Aug. 1, 2013, entitled “ARTICULATED WATERING DEVICE”, which is incorporated by reference herein in its entirety for all purposes.

### BACKGROUND

The present invention is in the general technical field of robotics, and more particularly, the present invention is in the technical field of robotic irrigation.

Conventional automated irrigation devices, such as underground piped irrigation systems, are typically too difficult to modify and perform poorly at irrigating specific plants. For example, it is difficult to modify an underground irrigation system because they are typically buried underground and require specialized knowledge to property configure or reconfigure. Further, underground irrigation systems typically waste a significant amount of water when they are being used to irrigate a small number of widely spaced plants. Further, it is not an uncommon experience for a newly installed plant to require a reconfiguration of an existing irrigation system, or the installation of a new irrigation system. Furthermore, conventional irrigation systems cannot readily be moved from location to location as homeowners move, remodel, or otherwise reconfigure their use of their property.

### SUMMARY

According to one aspect of the present invention, a computer controlled device which can dispense fluids in a targeted manner is provided. In one example, an electronically controlled device provides the ability to irrigate a specific item or items of vegetation or area of land, without unnecessarily irrigating areas which were not intended to be affected by water, e.g., surrounding areas or area between vegetation. Additionally, certain examples of the present invention include the ability to schedule irrigation routine frequency and duration in a location specific manner.

The present invention may include the ability to dispense water, pesticides, fungicides, cleaners or other fluids through one or more fluid exhaust ports. This present invention can be configured by a person or persons to store broad regions, specific areas, or a combination thereof so as to allow repeated application of fluid to those specific areas and regions over time. The configuration of the device may be accomplished via an external computing device such as a laptop, tablet, smartphone etc. The configuration of the present invention may also occur via an onboard computing device, including a screen and associated controls. The transmission of the configuration data, as well as information transferred from the present invention may occur through means such as, but not limited to, Ethernet, modem, electrical mains data transmission, Wireless networking, Bluetooth, Xbee, Infrared, or other wired and/or wireless data transmission patterns. Configuration data may reside in the memory of the device itself either partly or entirely, or the configuration data may exist partly or entirely on an external device such as a smartphone, tablet, or server. The present invention may also work in coordination with other devices to affect fluid delivery patterns.

### BRIEF DESCRIPTION OF THE DRAWINGS

Non-limiting and non-exhaustive embodiments of the present invention are described with reference to the following figures, wherein like reference numbers refer to like parts throughout the various views unless otherwise specified.

FIG. 1 is a perspective view of an exemplary robotic irrigation device of the present invention according to one example.

FIG. 2A is a diagram view of a logical process of the present invention according to one example.

FIG. 2B is an exemplary process for controlling a robotic irrigation device according to one example.

FIG. 3 is a top down view of an exemplary irrigation pattern of the present invention according to one example.

FIG. 4 is a diagram view of exemplary communication patterns between the present invention and the configuration devices.

FIG. 5 illustrates an exemplary computer system that may be used with or in communication with the exemplary irrigation device described herein.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment,” “an embodiment,” “one example,” or “an example” means that a particular feature, structure, or characteristic described in connection with the embodiment or example is included in at least one embodiment of the present invention. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or subcombinations in one or more embodiments or examples. In addition, it should be appreciated that the figures provided herewith are for explanation purposes to persons ordinarily skilled in the art and that the drawings are not necessarily drawn to scale.

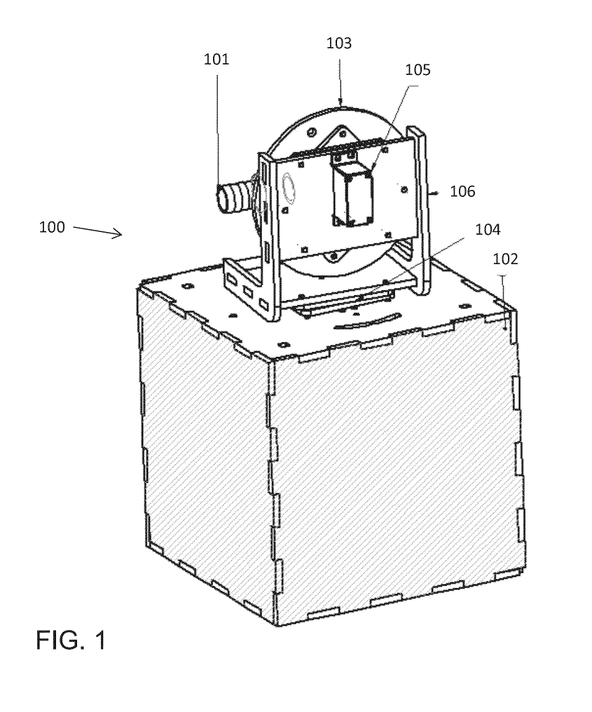

Referring to FIG. 1 there is shown an exemplary device 100 according to one example of the present invention, device 100 having a platform 102 which provides the base for both a panning assembly 104 and a tilting assembly 103, which are supported and connected by a ridged structure 106. The platform 102 provides a fixture to support the input of fluid to the device via tubing, hose, and/or rigid coupling. Platform 102 may also provide, for example, fixtures for electrical wiring to enter the device for power and/or data transmission. Each rotating assembly is controlled by a motor or motors 105, which induce the rotation of the assembly.

In more detail, still referring to the example of FIG. 1, device 100 has one or more fluid exhaust ports 101 (only one shown in FIG. 1), which direct fluid towards one or more intended targets or regions. Each fluid exhaust port may be of different orientation, diameter, or exhaust pattern so as to provide various fluid exit angles, velocities, flow rates, and/or fluid exit patterns. Two examples of fluid exit patterns may include a directed laminar stream of fluid, and a distributed array of low velocity droplets in a manner similar to the manner in which rainfall naturally occurs. Furthermore each of these fluid exhaust ports may be independently controlled from each other fluid exhaust port, or all fluid exhaust ports may all move in unison, or any combination thereto.

In addition to having one or more fluid exhaust nozzles, device 100 may include control mechanisms to enable, disable, adjust, or maintain direction in which the fluid leaves the device. For example, the device can include the ability to adjust the location that a fluid, such as water, may land on the ground by adjusting water pressure, yaw axis (left/right control) and/or tilt axis (vertical control). As another example, the device may modify the water pressure so as to maintain water velocity and/or location in which the water lands, as compensation for varying water pressure into the device, or to compensate for wind in the environment.

Further, each fluid exhaust port 101 may include variable valve openings or pressure mechanisms to control the volume or velocity of fluid exiting therefrom. Again, in examples having multiple fluid exhaust ports 101, each may be separately controlled or controlled in unison.

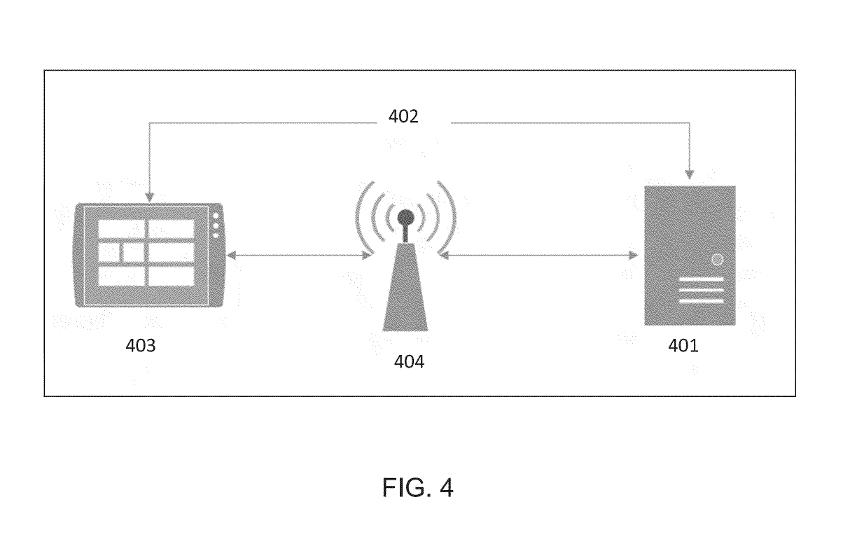

The construction details of the exemplary device 100 as shown in FIG. 1 are that the device may be made of wood or other sufficiently rigid and strong material such as high-strength plastic, metal, a composite material, or the like. Further, the various components of the device can be made of different materials, for example, a metal nozzle, high-strength plastic forming the panning and tilting assembly, and the like. Further, platform 102 may include an interface (as described below and shown in FIG. 4) for inputting pattern and timing information, and/or may include a physical port or wireless connection for receiving pattern and timing information from an external interface.

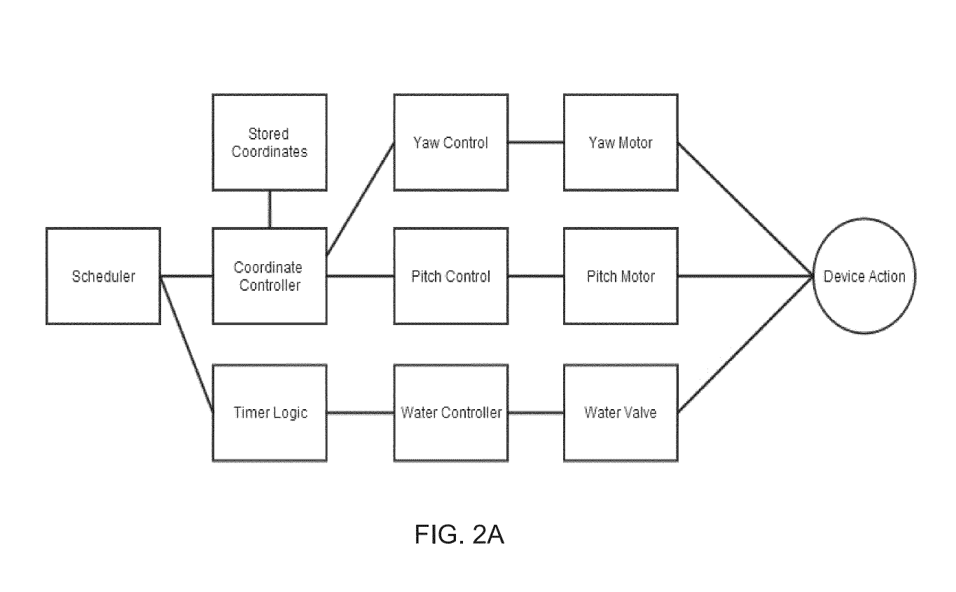

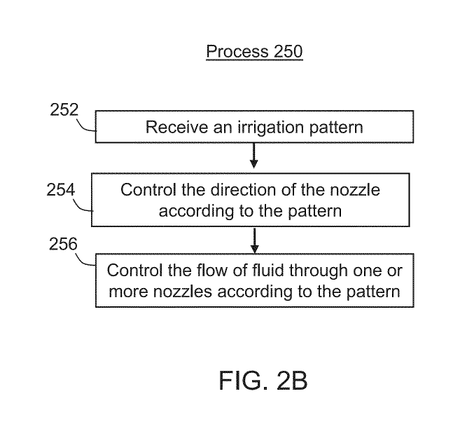

FIG. 2A illustrates an exemplary schematic of the logical components of a computer program or set of programs having various subcomponents operable for controlling the behavior of device 100. These components include, without limitation, a scheduler which controls the frequency of the actions of the device, a timer which controls the duration of the action of the device, a repository of stored locations for which the motors can articulate the output of the device to, a controller to affect the enabled/disabled state of the valve for releasing fluid, a pitch controller which affects the angle of the water output in a vertical or near-vertical manner, a yaw controller which affects the angle of the water output in a horizontal or near-horizontal manner, and one or more motors which convert the electrical signals into mechanical actions. Any of these subcomponents may reside and execute on the device itself, or they may reside and execute on a computer system outside of the device; such computer systems may communicate with the device via wired and/or wireless mechanisms.

It should be recognized that in other examples of device 100, e.g., that include different mechanism for directional control, water pressure control, or fluid selection, different logical components may be used. For example, additional components for controlling nozzle size, flow rates, fluid source, and so on may further be implemented. Additionally, components for controlling and coordinating multiple fluid exhaust ports may be implemented.

FIG. 2B is an exemplary process 250 for controlling a robotic irrigation device according to one example. The exemplary process may be carried out by a processor or controller included locally or remotely to the robotic device. At 252 the process includes receiving a desired irrigation pattern. For example, a user may input, through a suitable interface, desired regions to be irrigated, how much fluid to dispense in different regions, timing of the fluid, and so on. At an appropriate time, the process at 254 may then control the direction of the exhaust port or nozzle to direct fluid according to the pattern. The process may further control the volume of liquid exhausted, the time for dispensing to different regions, and so on, as indicated at 256. It should be understood that the exemplary process 250 may include other processes and that some process may occur in parallel.

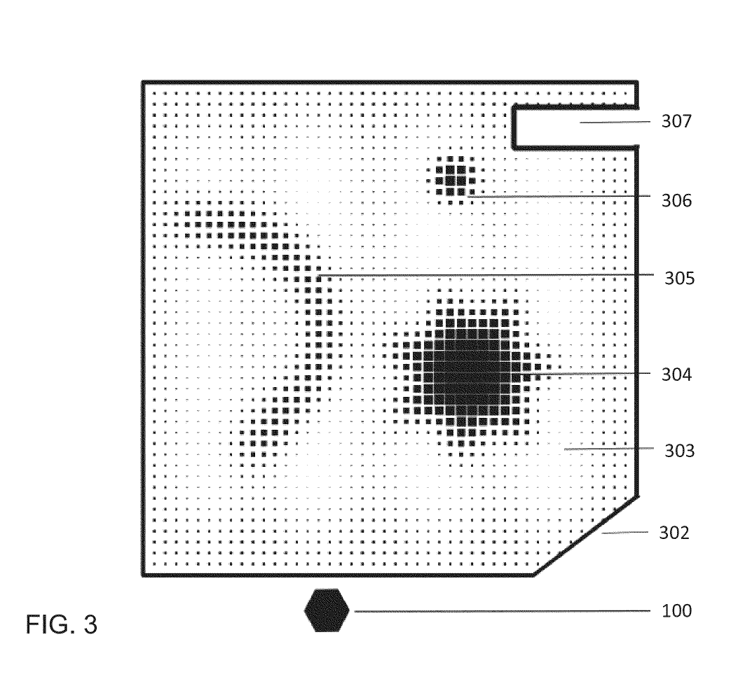

Referring now to FIG. 3, there is shown an exemplary fluid delivery pattern from a top-down perspective of an automated deliver device such as device 100. For the purposes of FIG. 3, the relative size of the darkened dots present in FIG. 3 shall be interpreted to indicate the relative amount of fluid delivery to a given position (e.g., darker indicating more fluid delivery). The device 100 is able to deliver fluid in a contained area 302 which need not be uniform in shape. Within this area 302 there may be subareas 303 which receive average or less than average fluid delivery to the area, and there may be subareas 304 which receive average or greater than average amounts of fluid. Additionally, there may be specifically designated areas 305 which are uniform or non-uniform in area and receive specific fluid delivery schedules different from others subareas within the larger area 302. The fluid delivery pattern is able to be updated at a later point in time if a new or different fluid delivery requirement is introduced 306. Lastly, there may be a subarea or subareas 307 which are restricted from receiving any fluid delivery, and thus, device 100 does not direct any fluid to these regions.

It should be apparent that the exemplary pattern is for illustrative purposes only and that various other patterns are contemplated, including patterns that encompass the device 100, i.e., encircle or extend 360 degrees around device 100. Further, “dry” regions may be included entirely within “wet” regions.

It should further be noted that different areas or subareas may receive fluid for different durations or at different times. For example, subarea 304 may receive fluid for a longer duration, may receive a larger volume over a similar time as other subareas, may receive fluid multiple times per day, and so on to achieve varying levels of fluid.

Referring now to FIG. 4, there are shown two exemplary communication patterns between an exemplary device of the present invention and an external configuration device (as noted above, configuration controls and an interface may also be included integral with the fluid delivery device 401). In one example, fluid delivery device 401 can communicate with a configuration device 403 through direct communication 402, which can include a wired connection. Alternatively, fluid delivery device 401 can communicate with a configuration device through indirect mechanisms 404 which can include but are not limited to a wireless router, Bluetooth host, network switch, powerline switch, or the like.

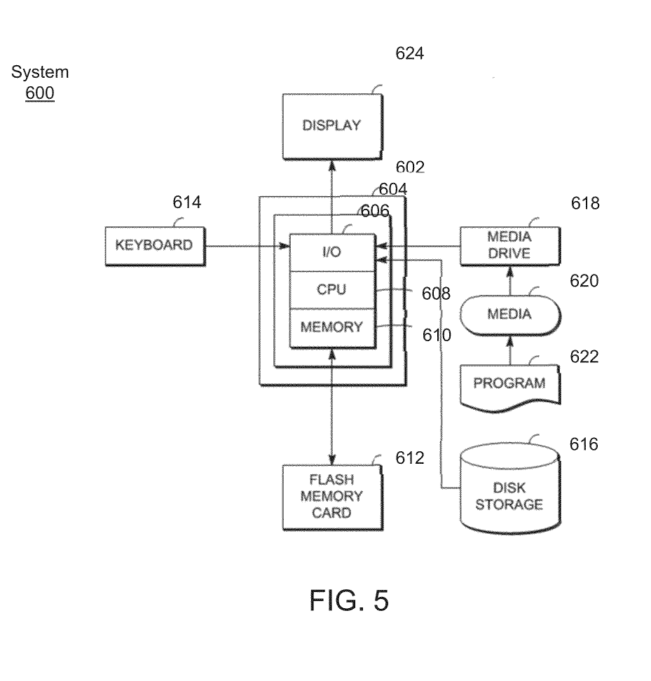

FIG. 5 depicts an exemplary computing system 600 configured to perform any one of the above-described processes, and which may be included entirely or in part with a fluid directing device or with a peripheral device operable to communication and/or control a fluid directing device. In this context, computing system 600 may include, for example, a processor, memory, storage, and input/output devices (e.g., monitor, keyboard, disk drive, Internet connection, etc.). However, computing system 600 may include circuitry or other specialized hardware for carrying out some or all aspects of the processes. In some operational settings, computing system 600 may be configured as a system that includes one or more units, each of which is configured to carry out some aspects of the processes either in software, hardware, or some combination thereof.

FIG. 5 depicts computing system 600 with a number of components that may be used to perform the above-described processes. The main system 602 includes a motherboard 604 having an input/output (“I/O”) section 606, one or more central processing units (“CPU”) 608, and a memory section 610, which may have a flash memory card 612 related to it. The I/O section 606 is connected to a display 624, a keyboard 614, a disk storage unit 616, and a media drive unit 618. The media drive unit 618 can read/write a computer-readable medium 620, which can contain programs 622 and/or data.

At least some values based on the results of the above-described processes can be saved for subsequent use. Additionally, a non-transitory computer-readable medium can be used to store (e.g., tangibly embody) one or more computer programs for performing any one of the above-described processes by means of a computer. The computer program may be written, for example, in a general-purpose programming language (e.g., Pascal, C, C++, Java) or some specialized application-specific language.

Various exemplary embodiments are described herein. Reference is made to these examples in a non-limiting sense. They are provided to illustrate more broadly applicable aspects of the disclosed technology. Various changes may be made and equivalents may be substituted without departing from the true spirit and scope of the various embodiments. In addition, many modifications may be made to adapt a particular situation, material, composition of matter, process, process act(s) or step(s) to the objective(s), spirit or scope of the various embodiments. Further, as will be appreciated by those with skill in the art, each of the individual variations described and illustrated herein has discrete components and features that may be readily separated from or combined with the features of any of the other several embodiments without departing from the scope or spirit of the various embodiments. All such modifications are intended to be within the scope of claims associated with this disclosure.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A computer controlled device for dispensing fluids in a targeted manner, the device comprising:
one or more nozzles for directing a fluid;
one or more motors for controlling the pitch and the yaw of the one or more nozzles;
one or more valves for controlling the flow of fluid from the nozzle; and
a controller for selectively directing the one or more nozzles to direct fluid in a predetermined pattern.

2. The computer controlled device of claim 1, wherein the controller controls the one or more motors and one or more valves to dispense liquid in a predetermined, non-uniform pattern.

3. The computer controlled device of claim 2, wherein the predetermined, non-uniform pattern is stored in a memory accessible by the controller.

4. The computer controlled device of claim 1, further comprising a user interface for inputting a dispensing pattern of fluid.

5. The computer controlled device of claim 4, wherein the user interface is remote from the device.

6. The computer controlled device of claim 4, wherein the user interface communicates with the controller wirelessly.

7. The computer controlled device of claim 1, further comprising a user interface for inputting a dispensing pattern of fluid, the user interface operable from a mobile device in communication with the controller.

8. A computer-enabled method for controlling a fluid dispensing device in a targeted manner, the method comprising:
controlling the direction of a nozzle in at least two dimensions based on a received pattern; and
controlling the flow of fluid through the nozzle to disperse the fluid according to the pattern.

9. The method of claim 8, wherein controlling the direction of the nozzle includes controlling each of the pitch and the yaw of the nozzle.

10. The method of claim 8, further comprising controlling a pressure of the fluid.

11. The method of claim 8, wherein controlling comprises controlling one or more motors to dispense liquid in a predetermined, non-uniform pattern.

12. The method of claim 8, further comprising receiving the pattern from a memory accessible by a controller for controlling the direction of the nozzle.

13. The method of claim 8, further comprising receiving the pattern from a user interface.

14. The method of claim 13, wherein the user interface is remote from the device.

15. The method of claim 13, wherein the user interface communicates with the controller wirelessly.

16. A computer readable storage medium comprising instructions for controlling a fluid dispensing device, the computer readable storage medium comprising instructions for:
controlling the direction of a nozzle in at least two dimensions based on a received pattern; and
controlling the flow of water through the nozzle to disperse fluid according to the pattern.

17. The computer readable storage medium of claim 16, wherein controlling the direction of the nozzle includes controlling each of the pitch and the yaw of the nozzle.

18. The computer readable storage medium of claim 16, further comprising instructions for controlling a pressure of the fluid.

19. The computer readable storage medium of claim 16, wherein controlling comprises controlling one or more motors to dispense liquid in a predetermined, non-uniform pattern.

20. The computer readable storage medium of claim 16, further comprising receiving the pattern from a memory accessible by a controller for controlling the direction of the nozzle.
